(19) United States
(12) Patent Application Publication
(10) Pub. No.: US 2010/0162149 A1
(43) Pub. Date: Jun. 24, 2010

(54) Systems and Methods to Provide Location Information

(75) Inventors: Daniel SHELEHEDA, Florham Park, NJ (US); Cynthia CAMA, Belmar, NJ (US); Yih-Farn CHEN, Bridgewater, NJ (US); Rittwik JANA, Parsippany, NJ (US); Bernard S. RENGER, New Providence, NJ (US); Bin WEI, Basking Ridge, NJ (US)

Correspondence Address: AT&T Legal Department - GT;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/343,873

(22) Filed: Dec. 24, 2008

(51) Int. Cl. G06F 3/048

(52) U.S. Cl. 715/764

(57) ABSTRACT

Systems and methods are provided to facilitate location based services based on locations in virtual worlds and locations in the real world. In one aspect, a location server obtains and provides the locations of avatars of users in different virtual worlds and the locations of mobile devices of the corresponding users in the real world. An application server, for example, may provide location based services in a virtual world based on the location of a mobile device in the real world, or provide location based services to a mobile device based on the location of an avatar in a virtual world, or provide location based services to an avatar in one virtual world based on the location of a related avatar in another virtual world.

### FIELD OF THE TECHNOLOGY

At least some embodiments of the disclosure relate to location based information and services.

### BACKGROUND

Virtual reality (VR) can create an illusion of reality or imagined reality. For example, a data processing system can simulate a real or imaginary system and provide an environment for a user to interact with the simulated system. A user can perform operations on the simulated system, explore the simulated system and receive feedback in real time.

A virtual reality environment may primarily provide visual experiences, displayed on a computer screen or through stereoscopic display devices, such as head-mount displays (HMD), liquid crystal display (LCD) shutter glasses, polarized glasses, anaglyph glasses, etc. A computer system may simulate a three-dimensional (3D) environment such that the visual experience of the user depends on the viewpoint of the user; and the user may continuously adjust his or her viewpoint to obtain a personal view of the simulated world in real time. Some virtual reality environments provide additional sensory experiences, such as sound, touch, etc., (e.g., through speakers or headphones for audio, haptic systems for motion or force feedback, etc.).

A virtual reality environment can offer users immersion, navigation, and manipulation. A virtual reality environment can make the users feel that they are present in the simulated world and their visual experience in the virtual world more or less matches what they expect from the simulated environment, a sensation sometime referred to as engagement or immersion.

Examples of virtual reality environments include various interactive computer environments, such as text-oriented on-line forums, multi-player games, and audio and visual simulations of a system. For example, a personal computer can simulate the view of a three-dimensional space on a computer screen and allow the user to virtually walk around and visually inspect the space; and via a data communication network many users can be immersed in the same simulation, each perceiving it from a personal point of view.

Some virtual reality worlds support a Massively Multi-player Online Role Playing Game (MMORPG), in which a user represented by an avatar can interact with other users who are also represented by their corresponding avatars. Controlled by an input device such as a keyboard, an avatar can move in the virtual reality world and even fly around to explore, meet people, engage in text chat, etc.

An avatar includes an image that represents a user. The appearance of an avatar may or may not resemble the user. An avatar may be in the shape of a human being, a cartoon character, or other objects. An avatar may be based on one or more photographs of the user. For example, the computer system may map a photo image of a user to generate an avatar that simulates the look and feel of the user. Alternatively, an avatar may not have any resemblance to the actual appearance of the user, to allow the user a completely different appearance in a virtual world.

In the real world, a user can be at one location at a time. A mobile device carried by the user may indicate the location of the user. For example, a cellular phone having a Global Positioning System (GPS) receiver may report the location of the cellular phone to obtain services based on its location.

In virtual worlds, a user may exist simultaneously in two or more virtual worlds as avatars. In some instances, a user may have two or more avatars in the same virtual world.

### BRIEF DESCRIPTION OF THE DRAWINGS

The embodiments are illustrated by way of example and not limitation in the figures of the accompanying drawings in which like references indicate similar elements.

FIG. 1 shows a system to provide location based services according to one embodiment.

FIG. 2 shows a system to associate locations with a user according to one embodiment.

FIGS. 3-8 illustrate methods to provide information based on locations in the real world and virtual worlds.

FIG. 9 shows a data processing system, which can be used in various embodiments.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

One embodiment of the disclosure provides systems and methods to facilitate location based services based on locations in virtual worlds and/or locations in the real world. In one aspect, a location server obtains and provides the locations of avatars of users in different virtual worlds and the locations of mobile devices of the corresponding users in the real world. An application server, for example, may provide location based services in a virtual world based on the location of a mobile device in the real world, or provide location based services to a mobile device based on the location of an avatar in a virtual world, or provide location based services to an avatar in one virtual world based on the location of a related avatar in another virtual world.

In one embodiment, a location server records and publishes location information about the virtual locations, regions, businesses and social environments in one or more virtual worlds visited by the user in the form of avatars. The virtual worlds may simulate the geographical space of a real world, allowing an avatar to travel from one geographical location to another location to visit virtual businesses and virtual social environments, for interaction with virtual objects and/or other users in the form of avatars.

The location server may provide the virtual and real world location information to an application server to present location based marketing and services to the user in the real world and/or in the virtual worlds. The services of the location server can enhance existing real world location based services and allow new forms of location based services in the virtual worlds.

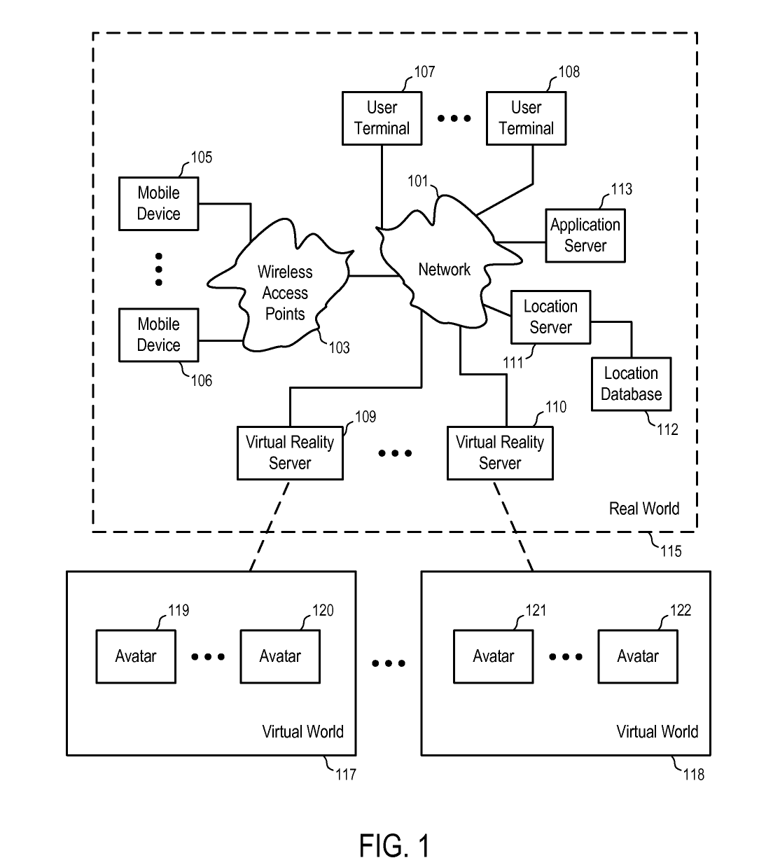

FIG. 1 shows a system to provide location based services according to one embodiment. In FIG. 1, the real world (115) includes the virtual reality servers (109-110) that host the corresponding virtual worlds (117-118). Users may use the user terminals (107-108) to access virtual worlds (117-118).

In one embodiment, a user terminal (e.g., 107 or 108) is a data processing system, such as a notebook computer, a personal computer, a workstation, a network computer, a personal digital assistant (PDA), a mobile phone, a cellular phone, microprocessor-based or programmable consumer electronics, and the like.

For example, a user may use the user terminal (107) to log into the virtual reality server (109) to visit the virtual world (117) as an avatar (1 19). The avatar (119) has a geographical location in the virtual world (117); and the virtual reality server (109) presents information to the user terminal (107) to allow the user to view the current surroundings of the avatar (119), such as virtual stores, virtual streets, virtual objects, etc., in the virtual world (117). The user may interact with other users, such as another user represented by a different avatar (120).

In one embodiment, different virtual worlds (117-118) require the users to visit different access points of the virtual reality servers (109-110) for authentication. Once authenticated, a user can visit different locations in the virtual world (117) as an avatar (119) associated with the identity of the user. The avatar (e.g., 119) can move within the virtual world (117) but cannot move into a different virtual world (118). To provide access to a separate virtual world (118), the virtual reality server (110) separately authenticates the user, before allowing the user to visit the virtual world (118) as a separate avatar (e.g., 121).

In some embodiments, a user may have more than one avatar in a virtual world. For example, a user may simultaneously control the avatar (121) and the avatar (122) using different user terminals (e.g., 107 and 108), or using different processes running on the same user terminal (e.g., 107). The avatars (e.g., 121 and 122) controlled by the same user may visit different locations in the virtual world, interacting with different sets of other avatars that represent other users.

Typically, different virtual worlds (e.g., 117-118) reside in different virtual reality servers (e.g., 109-110). However, some virtual worlds (e.g., 117-118) may share the hardware that run the virtual worlds, such as virtual reality servers, storage facilities, etc. In some embodiments, a plurality of virtual reality servers (109) communicate with each other to host one virtual world, which may have a large number of virtual objects and avatars mapped in a large virtual geographical area. In some embodiments, a virtual world (e.g., 117) may include a set of separate geographical areas; an avatar (e.g., 119) may not be able to move from one geographical area to another geographical area in the virtual world via a continuous path; however, the avatar (e.g., 119) may travel from one geographical area of the virtual world (e.g., 119) to another geographical area of the virtual world (e.g., 120) instantaneously (e.g., via teleporting).

In FIG. 1, the virtual reality servers (109-110) present the views of the virtual worlds (117-118) as seen by the corresponding avatars (119-120, 121-122) based on their current locations and/or view points in the virtual worlds. The avatars (119-120, 121-122) may be on a smooth, geographical area (e.g., a virtual continent or a virtual island). Some virtual objects, such as virtual streets, virtual stores, etc., may have fixed locations in these geographical areas to provide services and/or virtual products. Some virtual objects, such as virtual vehicles, may move continuously around such geographical areas and may sometime be absent from such geographical areas.

In FIG. 1, the virtual reality servers (109-110) present the views to the user terminals (107-108) over the network (101). The network (101) may include a local area network, a wireless data communication network, a telephone network, a cellular communication network, a telecommunication network, an interactive television network, a packet network, an Internet Protocol Television (IPTV) network, an intranet, or a combination of networks, such as Internet.

In FIG. 1, the users may use the mobile devices (105-106) to access the network (101) via the wireless access points (103), such as access points for wireless local area networks, base stations for cellular communications and/or wireless wide area networks, etc. The users may use the mobile devices (105-106) to access the virtual reality servers (109-110), to communicate with the location server (111), to access the application server (113), to communicate with the user terminals (107-108) or other mobile devices (105-106), or to access other resources (not shown in FIG. 1) over the network (101).

In FIG. 1, a location server (111) communicates with the mobile devices (105-106) and/or the wireless access points (103) to obtain the locations of the mobile devices (105-106) in the real world (115). The location server (111) communicates with the virtual reality servers (109-110) over the network (101) to obtain the locations of the avatars (119-120 and 121-122) in the virtual worlds (117-118), either directly or indirectly.

In one embodiment, the location server (111) is independent from any of the virtual reality servers (109-110). In other embodiments, the location server (111) may be integrated with one or more of the virtual reality servers (109-110).

In one embodiment, the location server (111) obtains and stores location information in the location database (112), such as the location information of the mobile devices (105-106) in the real world and the location information of the avatars (119-120 and 121-122) in the virtual worlds (117-118). The location server (111) tracks the locations of the mobile devices (105-106) and the avatars (e.g., 119-120 and 121-122) and associates the locations of the mobile devices (105-106) in the real world (115) and the locations of the avatars (e.g., 119-120 and 121-122) in the virtual worlds (117-118) with their corresponding users to facilitate location-based services.

For example, the location server (111) may provide the location information to an application server (113), which uses the location information to selectively deliver information and/or services to the mobile devices (105-106) and/or the avatars (119-120 and 121-122). Other application serves (not shown in FIG. 1) can also communicate with the location server (111) to provide different or similar location based services.

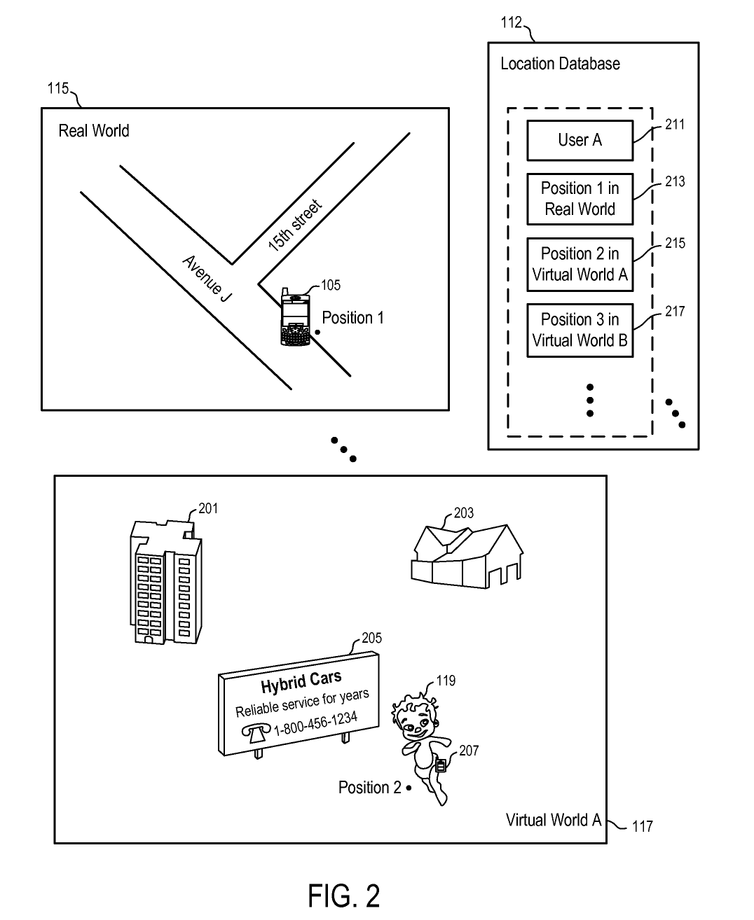

FIG. 2 shows a system to associate locations with a user according to one embodiment. In FIG. 2, the location database (112) stores the different positions (213, 215, 217, . . . ) of the user (211) in the real world (115) and in the virtual worlds (e.g., 117-118).

For example, the user may register a mobile device (105) with the location server (111) to track the position (213) of the mobile device (105) of the user in the real world (115).

For example, the mobile device (105) may include a cellular phone with a location determination unit, such as a GPS receiver, to determine the current position (213) of the mobile device (105). The mobile device (105) may automatically report the current position (213) of the mobile device (105) to the location server (111) via the network (101). Alternatively, a cellular phone may use a cell tower triangulation method to determine its current position. Alternatively, a set of cell towers may determine signal delays from the cellular phone to determine the position of the cellular phone via triangulation. In some embodiments, the mobile device (105) presents a map, or a text entry box, or other types of user interfaces to allow the user to specify the location of the mobile device (105) manually. In some embodiments, the mobile device (105) includes a navigational device, such as a GPS-based portable navigation system.

In FIG. 2, the user may register an avatar (119) with the location sever (111) to track the position (215) of the avatar (119) in virtual world (117).

Based on the user registration information, the location database (112) associates the locations (213-217) of a user with each other and with the identity (211) of the user (and/or other information about the user, such as the phone number of the mobile device (105), preferences of the user, etc.)

In one embodiment, the location database (112) stores location information (213-217) based on coordinates of the corresponding positions in the virtual worlds (117-118) and in the real world (115). Alternatively, the location database (112) may store the location information (213-217) in the form of street addresses, regions or areas, businesses or social environments at or near the corresponding locations, etc.

In one embodiment, the location database (112) stores not only the current locations of the mobile device (105) and the avatar (119), but also the history of locations visited by the mobile device (105) and the avatar (119). An application server (113) may determine location-based services based on not only the current locations but also on past locations.

In one embodiment, the avatar (119) may acquire and carry a virtual object (207) (e.g., a virtual cellular phone) that can report its position in the virtual world to the location server (111). Since the user attaches the virtual object to the avatar (119), the location of the virtual object can be used to represent the location of the avatar (119).

In FIG. 2, the virtual object (207) has a visual appearance after the user attaches the virtual object (207) to the avatar (119). In other embodiments, the virtual object (207) may not have a visible appearance after the user attaches the virtual object (207) to the avatar (119).

In one embodiment, the virtual object (207) uses a communications system provided by the virtual reality server (e.g., 109) to communicate the position (215) of the avatar (119) to the location server (111). For example, the virtual reality server (e.g., 109) may provide an instant messaging system, or an email system, that allows an avatar or a virtual object to send messages from within the virtual world (117) to the outside of the virtual world (117). The virtual object (207) can use such communications systems to report the position (215) of the avatar (119) to the location server (111) over the network (101).

In one embodiment, the virtual object (207) is a location-tracking object that reports the location of the avatar (119) to the location server (111) periodically, or based on some trigger, such as a user initiated, temporal or event based action. The virtual object (207) may report information to the location server (111), including an identity of the virtual world (e.g., 117) in which the avatar (119) is present, the name of the avatar (119), the region and vector coordinates of the location of the avatar (119), an identification of the virtual object (207), and the date and time. In some embodiments, the user of the avatar (119) may further provide information to augment the location information, such as comments, a rating of the user's interest level regarding the business or social area they are visiting, information regarding the virtual world (117), comments about the user's current experience, etc.

In one embodiment, a virtual object (205) can be a user-sensing object. The user-sensing object (e.g., 205) can scan the vicinity to detect the presence of avatars (e.g., 119). Once the avatar (119) is within the detection range of the virtual object (205), the virtual object (205) may report the presence of the avatar (119) in the vicinity of the virtual object (205) to the location server (111).

In one embodiment, the virtual object (205) is at a fixed location in the virtual world (117). Alternatively, some user sensing objects (not shown in FIG. 2) may move around in the virtual world (e.g., 117) to detect avatars (119) that are within a certain range from these user-sensing objects. For example, a virtual object in the form of a car or an airplane may scan avatars along a route. Some virtual reality servers (e.g., 109 or 110) may impose the limit on the range a virtual object can scan for avatars.

In one embodiment, the location server (111) may employ a number of avatars to detect the presence of other avatars. For example, some service providing avatars may “see” other potential customer avatars that are within their view and report the presence of the potential customer avatars to the location sever (111).

In one embodiment, the virtual reality sever (e.g., 109) may notify an avatar (119) of its friends (120) that are in the same virtual world (117). The location server (111) may ask the users to register their avatars (e.g., 119-120, 121-122) with the location server (111) by becoming a friend of one or more avatar representatives of the location server (111). Thus, the virtual reality server (e.g., 109) will notify the avatar representatives of the locations of registered avatars of the users; and the location server (111) may communicate with the avatar representatives to obtain the location information of the registered avatars in the virtual worlds (e.g., 117-118).

The virtual object (207) may transmit the location information of the avatar (119) from the virtual world (117) to the location server (111) via a defined protocol. The virtual object (207) may transmit the location information in response to user-initiated actions, or based on temporal or event driven schemes.

In some embodiments, the location server (111) may directly communicate with the virtual reality server (109) (e.g., via an application programming interface, via email, instant messaging, etc.) to obtain the location information of the registered avatars (e.g., 119-120, 121-122) of the users. For example, the location server (111) may query the virtual reality server (109) for the current location of a registered avatar (e.g., 119); or the virtual reality server (e.g., 109) may periodically report the location of the registered avatar (e.g., 119) in the virtual world (117) to the location server (111).

In some embodiments, the virtual reality sever (109) may provide log files to the location server (111); and the location server (111) can parse through the log files to obtain the location information and/or location history of a registered avatar (e.g., 119).

In FIG. 2, the location database (112) associates the different locations of the user's mobile devices and avatars with each other (and/or the history of the locations). In some embodiments, the location database (112) not only associates the different locations of a user with each other, but also associates the locations with the region and business or social site visited. In some embodiments, the location database (112) further links the location information (213-217) of the user (211) with the user accounts in social networking websites to enhance presence information. Thus, the application server (113) can communicate with the location database (112) (e.g., via the location server (111)) to provide various new location based services.

In one embodiment, the application server (113) supports multiple downstream subscribers including internally or externally hosted software applications or acts as a proxy to end users. The proxy to end users enables a service provider to provide “presence” information. Presence information typically shows the availability of a person or resource. Presence status can be binary in a simple use case (online/offline) or multi-valued (busy, invisible, mood etc.) in a complex use case. Rich presence information (e.g., in a Presence Information Data Format (PIDF) according to http://www.ietf.org/rfc/rfc3863.txt, or Rich Presence Extensions to the Presence Information Data Format (PIDF) according to http://www.ietf.org/rfc/rfc4480.txt) can be associated with an avatar. This presence information in combination with location information can be used to provide more advanced location based servers.

In one embodiment, a location-based service includes bi-directional interfaces between a virtual reality server (e.g., 109 or 110), the location server (111) and the application server (113).

For example, the application server (113) may use the virtual world and real world location information (e.g., 213-217) to provide location based marketing and services in both real world (e.g., via the mobile device (105)) and virtual world (e.g., via the avatar (119)).

For example, the location-based information may provide preference based marketing and advertising to the avatar (119) during subsequent visits to any of the virtual worlds (e.g., 117-118) visited by that avatar (119) through virtual billboards (e.g., 205) and other facilities. The advertisement can be based on the location history of the real person that corresponds to the avatar (119), based on the history of another avatar associated with this person, and/or based on the location history (not just the current location) of the avatar (119) in the virtual world (117).

For example, the application server (113) may augment the real world experience of the user via providing location-based services to the mobile device (e.g., 105) of the user.

For example, the application server (113) can use the virtual world location information (215-217) to provide personalized advertisements/content to the mobile device (105) (e.g., a cellular phone) targeted to the user who opts in.

For example, the application server (113) may provide the availability of the user in the real world to his friends in the virtual worlds (117-118). Applications in the virtual worlds (117-118) may use this presence information to notify the user in the real world via the mobile device (105). If the user is busy in a meeting, his friend's avatar (e.g., 120) may choose to communicate with the user using text messages or voicemail. For example, if the user knows that the location and presence status of a friend's avatar (e.g., busy-do-not-disturb, avatar watching a live concert) in the virtual world (117), the user may choose to delay any communication.

In one embodiment, the application server (113) may support bi-directional targeted marketing and advertising services in social networking sites, based on the location information provided by the location database (112).

For example, the application server (113) may provide avatar to avatar location services across virtual worlds.

For example, the location server (111) may provide location information to augment the online status of a user on a social network website with location info and/or the presence information of the user in various worlds.

For example, the application server (113) may analyze the location information (e.g., 213-217) to provide metrics, such as the number of visitors, returning visitors, their length of stay, etc., to allow the providers of the virtual worlds (117-118) to understand and improve the use patterns of their virtual land.

For example, the application server (113) may provide a map of a virtual world and/or the real world to a user to show the locations of friends of the user. For example, a map of the virtual world may show the locations of the avatars of the real world friends of the user. For example, a map of the real world may show the locations of the mobile devices associated with the avatar friends of the user in the virtual world; and the locations of the mobile devices may be selectable on the map to teleport the user into the vicinity of the corresponding avatar friends in the virtual world. The application server (113) may host group communications for friends that are within the vicinity of a specific location, or locations, such as the locations of one or more organizers in the real world and in at least one virtual world.

For example, based on a calendar that contains events (e.g., concert, movie, shows, dance, etc.) scheduled at certain times and locations, the application server (113) may use the location information about the users to send reminder to the users who are nearby the locations of the events to attend the events. In one embodiment, the application server (113) reminds the users who are nearby the corresponding locations of the events and who have signed up for the events. In another embodiment, the application server (113) reminds the users who are nearby the corresponding locations of the events and who have signed up for the reminder services without having to previously sign up for the individual events.

For example, the application server (113) may selectively publish or hide the location information for certain users (e.g., based on preferences settings) to improve privacy. As more and more shared resources, such as location, presence, etc., become prevalent in virtual worlds and the real world, there is a growing concern to control access to these resources. In one embodiment, the location server (111) provides privacy protection to limit the distribution of location information by utilizing the IETF (“Geographic Location/Privacy” (GEOPRIV) protocols of the Internet Engineering Task Force (IETF). More information about IETF GEOPRIV can be found at http://www.ietf.org/html.charters/geopriv-charter.html. The location server (111) provides the policies to access the location information together with the location information to improve privacy protection.

As an example, consider an entity (e.g., a supplier of location/presence information) that wishes to distribute location information which may be locations in the real or virtual world(s) according to embodiments of the disclosure. A watcher (e.g., a location recipient, such as an end user or an application) wants to fetch the location information published by the entity. The location object, which contains the location information and authorization policies, is sent to the watcher confidentially. Before further distribution of the location object by the watcher to other recipients, the attached policies need to be inspected. The location server (111) makes the authorization policies available (e.g., through the location object) for the evaluation of whether a particular recipient is allowed to retrieve certain location items in one embodiment. In another embodiment, the location server (111) evaluates whether a particular recipient is allowed to retrieve certain location items based on the authorization policies at the location server (111).

For example, the application server (113) may selectively provide presence information that may include indications of current activities of the users, their environments, and their locations.

In one embodiment, the application server (113) may associate the cellular phone number of the user with the location information of the user to allow the users to communicate data and messages such as instant messages, text messages, voice calls, messages via short message service (SMS), messages via multimedia message service (MMS), etc., into and out of the virtual world environments, via a connection between the cellular phone of a user and the avatar of the user.

For example, a virtual object (e.g., 207) not only tracks the location of the avatar (119) that carries the virtual object (e.g., 207), but also redirects data and messages to the mobile device (105) (e.g., via the location server (111) and/or the application sever (113)).

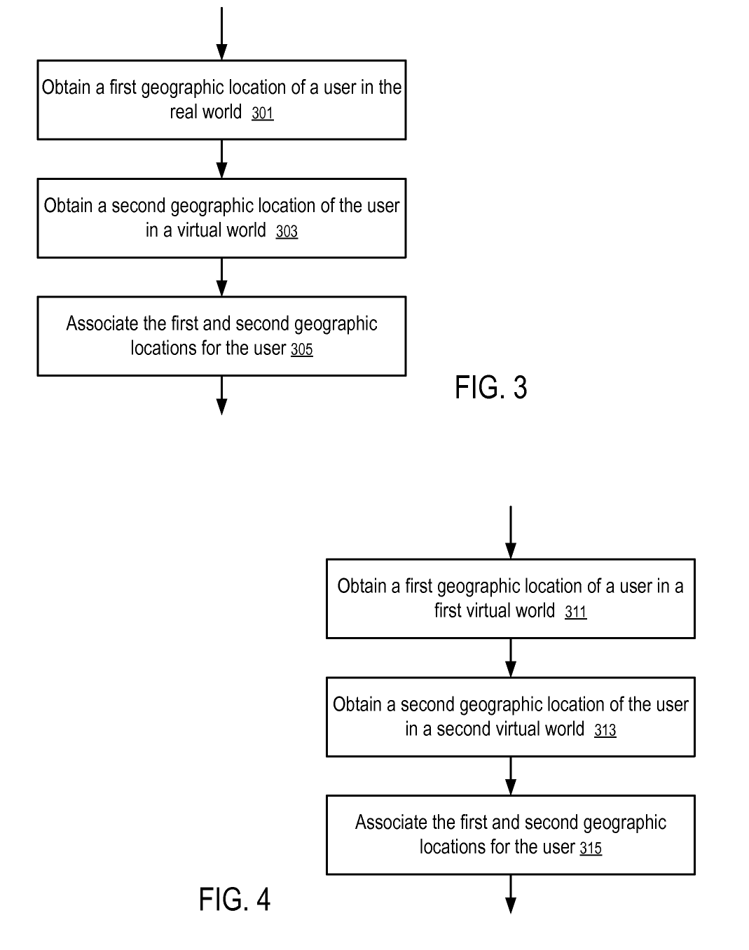

FIGS. 3-8 illustrate methods to provide information-based locations in the real world and virtual worlds.

In FIG. 3, the location server (111) obtains (301) a first geographic location of a user in the real world. The location server (111) obtains (303) a second geographic location of the user in a virtual world (e.g., 117). The location server (111) associates (305) the first and second geographic locations of the user in the location database (112). Through this association, the location server (111) can bridge the location information about the user (211) across the divide between the real world (115) and the virtual world (117).

In FIG. 4, the location server (111) obtains (311) a first geographic location of a user in a first virtual world (e.g., 117). The location server (111) obtains (311) a second geographic location of the user in a second virtual world (e.g., 118). The location server (111) associates (315) the first and second geographic locations of the user in the location database (112). Through this association, the location server (111) can bridge the location information about the user (211) across the divide between the virtual worlds (e.g., 117 and 118).

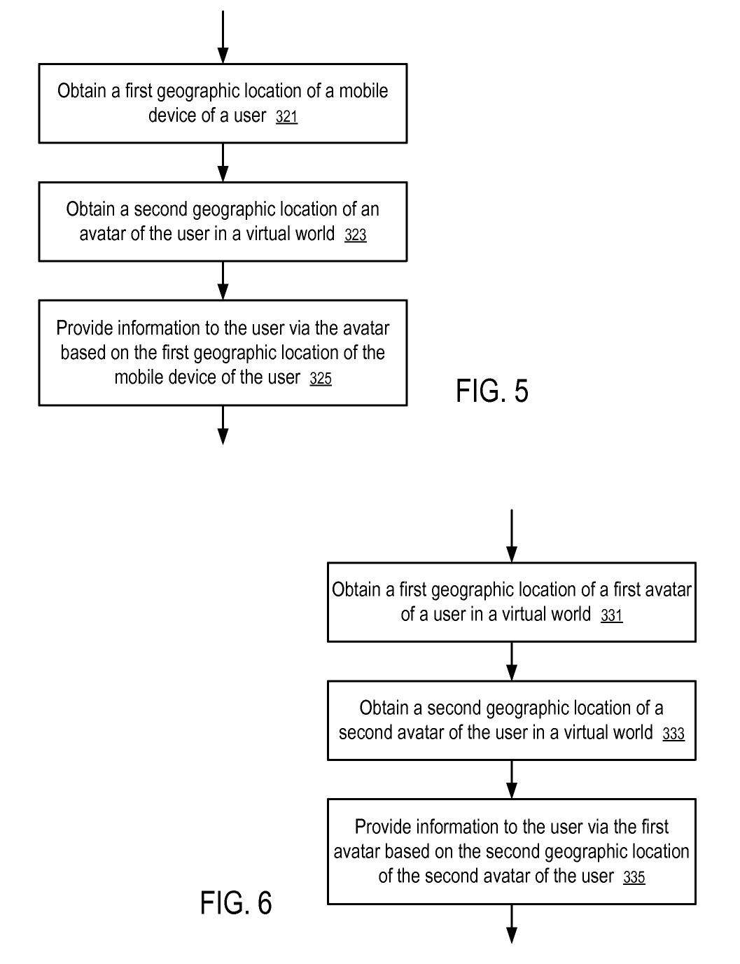

In FIG. 5, the location server (111) obtains (321) a first geographic location of a mobile device (105) of a user. The location server (111) obtains (323) a second geographic location of an avatar of the user in a virtual world (117). The application server (113) communicates with the location server (111) to provide (325) information to the user via the avatar (119) based on the first geographic location of the mobile device of the user. In some embodiments, the information is further based on the second geographic location of the avatar of the user. For example, the application server (113) may match the location of the avatar and the location of the mobile device in their relationship to certain business entities or objects of interests to provide advertisements, directions, etc.

For example, if the avatar (119) of a user is approaching a virtual billboard (205) in the virtual world (117) and the application server (113) determines that the mobile device (105) of the user has visited a retail store of a particular product in the real world (115) within a predetermined period of time (or is currently in the retail store), the application server (113) may use the virtual billboard (205) to present advertisements to the user, via the avatar (119), for related products.

In FIG. 6, the location server (111) obtains (331) a first geographic location of a first avatar of a user in a virtual world. The location server (111) obtains (333) a second geographic location of a second avatar of the user in a virtual world. The application server (113) communicates with the location server (111) to provide (335) information to the user via the first avatar based on the second geographic location of the second avatar of the user. For example, the second geographic location of the second avatar of the user may be an indication of an interest of the user in certain products, services, objects, etc.; and when the first avatar of the user is present in the first geographical location near the products, services, objects, etc., the application server (113) may provide information, directions, advertisements, discount offers, etc. to the user via the first avatar.

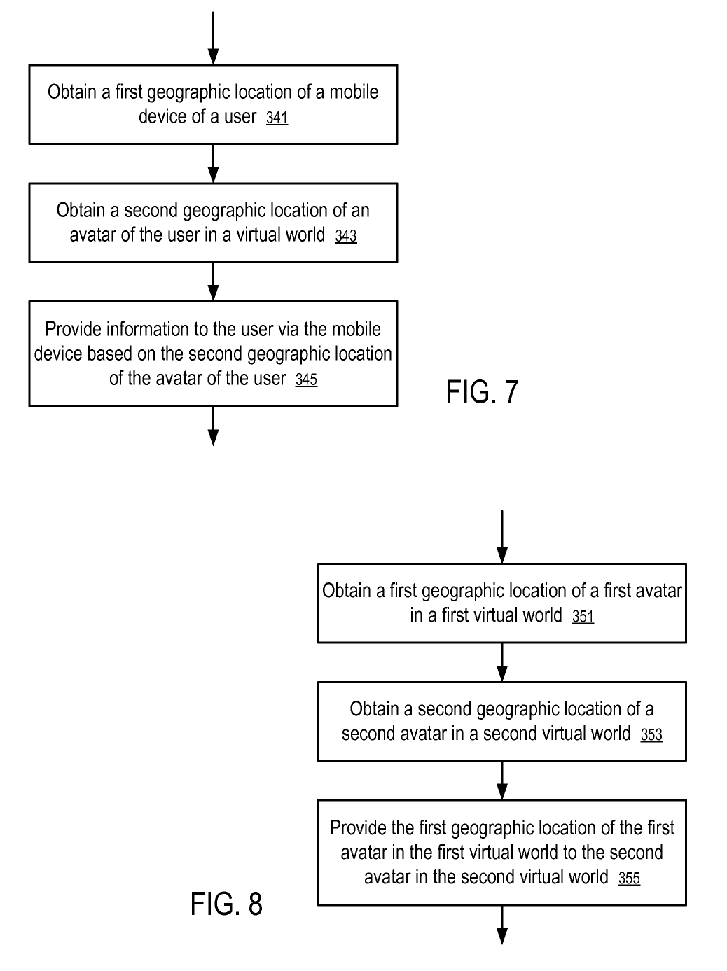

In FIG. 7, the location server (111) obtains (341) a first geographic location of a mobile device of a user. The location server (111) obtains (343) a second geographic location of an avatar of the user in a virtual world. The application server (113) communicates with the location server (111) to provide (345) information to the user via the mobile device (106) based on the second geographic location of the avatar of the user.

For example, if the mobile device (105) of a user is approaching a retail store of a business and the application server (113) determines that the avatar (119) of the user has visited a virtual store of the business in the virtual world (117), the application server (113) may prompt the user via the mobile device to visit the retail store in the real world (115), to provide directions to the retail store, and/or to provide advertisements and/or electronic coupons for the products or services offered in the retail store.

In FIG. 8, the location server (111) obtains (351) a first geographic location of a first avatar of a user in a first virtual world. The location server (111) obtains (353) a second geographic location of a second avatar in a second virtual world. The application server (113) communicates with the location server (111) to provide the first geographic location of the first avatar in the first virtual world to the second avatar in the second virtual world.

For example, the second avatar may be a friend of the user of the first avatar in a social network. This friend may also have an avatar in the first virtual world. The application server (113) may provide the location and the presence information of the first avatar to the second avatar to allow the friend to go to the vicinity of the first avatar in the first virtual world (e.g., in response to the avatar of the friend being in certain locations and/or in a certain mood).

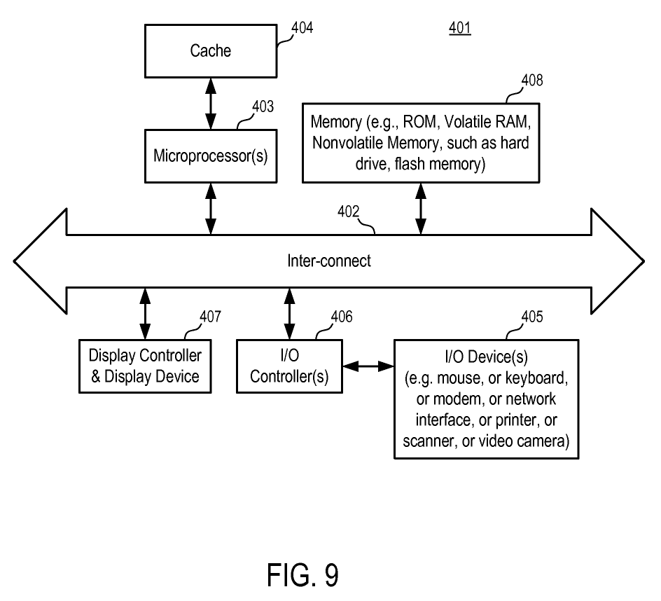

FIG. 9 shows a data processing system, which can be used in various embodiments. While FIG. 9 illustrates various components of a computer system, it is not intended to represent any particular architecture or manner of interconnecting the components. Some embodiments may use other systems that have fewer or more components than those shown in FIG. 9.

In one embodiment, each of the location server (111), the location database (112), the application server (113), the mobile devices (105-106), the user terminals (107-108) and the virtual reality servers (109-110) can be implemented as a data processing system, with more or less components, as illustrated in FIG. 9.

In FIG. 9, the data processing system (401) includes an inter-connect (402) (e.g., bus and system core logic), which interconnects a microprocessor(s) (403) and memory (408). The microprocessor (403) is coupled to cache memory (404) in the example of FIG. 9.

The inter-connect (402) interconnects the microprocessor(s) (403) and the memory (408) together and also interconnects them to a display controller, a display device (407), and to peripheral devices such as input/output (I/O) devices (405) through an input/output controller(s) (406).

Typical I/O devices include mice, keyboards, modems, network interfaces, printers, scanners, video cameras and other devices which are well known in the art. In some embodiments, when the data processing system is a server system, some of the I/O devices, such as printer, scanner, mice, and/or keyboards, are optional.

The inter-connect (402) may include one or more buses connected to one another through various bridges, controllers and/or adapters. In one embodiment, the I/O controller (406) includes a USB (Universal Serial Bus) adapter for controlling USB peripherals, and/or an IEEE-1394 bus adapter for controlling IEEE-1394 peripherals.

The memory (408) may include ROM (Read Only Memory), volatile RAM (Random Access Memory), and non-volatile memory, such as hard drive, flash memory, etc.

Volatile RAM is typically implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data, which when executed by a data processing system, causes the system to perform various methods. The executable software and data may be stored in various places including, for example, ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in the same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include, but are not limited to, recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

The computer-readable media may store the instructions. The instructions may also be embodied in digital and analog communication links for electrical, optical, acoustical or other forms of propagated signals, such as carrier waves, infrared signals, digital signals, etc.

In general, a tangible machine-readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations that are not order-dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer implemented method, comprising:
obtaining geographical location information of a user in at least two worlds of a plurality of virtual worlds hosted on virtual reality servers and the real world;
associating the geographical location information in the at least two worlds with the user using a computer; and
providing the geographical location information via the computer to facilitate at least one location based service.

2. The method of claim 1, wherein the obtaining of the geographical location information comprises obtaining a location of a mobile device of the user in the real world.

3. The method of claim 2, further comprising:
providing information to the user via an avatar of the user in the virtual world based on the location of the mobile device of the user in the real world.

4. The method of claim 1, wherein the obtaining of the geographical location information comprises obtaining a location of an avatar of the user in a virtual world.

5. The method of claim 4, wherein the computer is separate from the virtual reality servers.

6. The method of claim 5, wherein the computer communicates with at least one of the virtual reality servers via an application programming interface to obtain the location of the avatar.

7. The method of claim 4, further comprising:
providing information to a mobile device of the user based on the location of an avatar of the user in the virtual world.

8. The method of claim 4, further comprising:
based on the location of an avatar of the user in the virtual world, providing information to a second avatar in a second virtual world.

9. The method of claim 8, wherein the second avatar represents the user in the second virtual world.

10. The method of claim 4, wherein the obtaining the location of the avatar of the user is in response to an action by the user.

11. The method of claim 4, wherein the obtaining the location of the avatar of the user includes:
providing an object in the virtual world;
associating the object with the avatar; and
determining the location of the avatar based on a location of the object.

12. The method of claim 11, further comprising:
connecting communications directed to the object to a mobile device of the user.

13. The method of claim 12, wherein the mobile device comprises a cellular phone.

14. The method of claim 13, wherein the communications comprise voice communications.

15. The method of claim 13, wherein the communications are in at least one of: text message, email message, instant message, message delivered to the mobile device via multimedia messaging service, and message delivered to the mobile device via short message service.

16. The method of claim 11, wherein the obtaining the location of the avatar of the user further includes:
transmitting the location of the avatar from the object in the virtual world to the computer via an instant messaging system.

17. The method of claim 4, wherein the obtaining the location of the avatar of the user includes:
providing an object in the virtual world;
scanning the vicinity of the object for avatars; and
determining the location of the avatar based on a location of the object.

18. The method of claim 1, wherein the geographical location information includes coordinates in at least one virtual world.

19. A machine readable storage media storing a plurality of instructions, the instructions causing a processor to perform a method, the method comprising:
obtaining geographical location information of a user in at least two worlds of a plurality of virtual worlds hosted on virtual reality servers and the real world;
associating the geographical location information in the at least two worlds with the user using the computer; and
providing the geographical location information via the computer to facilitate at least one location based service.

20. A system, comprising:
means for obtaining geographical location information of a user in at least two worlds of a plurality of virtual worlds hosted on virtual reality servers and the real world;
means for associating the geographical location information in the at least two worlds with the user using a computer; and
means for providing the geographical location information via the computer to facilitate at least one location based service.
